(19) United States
(12) Patent Application Publication
(10) Pub. No.: US 2011/0106380 A1
(43) Pub. Date: May 5, 2011

(54) Vehicle surrounding monitoring device

(75) Inventors: Bingchen Wang, Okazaki-city (JP); Hideki Ootsuka, Anjo-city (JP)

(73) Assignee: DENSO CORPORATION, Kariya-city (JP)

(21) Appl. No.: 12/923,206

(22) Filed: Sep. 9, 2010

(30) Foreign Application Priority Data
Nov. 2, 2009 (JP) 2009-251980

(51) Int. Cl. H04N 7/18; G06F 7/00; B60Q 1/48

(52) U.S. Cl. 701/36; 348/148; 340/932.2; 348/E07.085

(57) ABSTRACT

A vehicle surrounding monitoring device includes an image display control section and a guide line overlapping section. The image display control section makes a view image based on a shot image of a surrounding of a vehicle and displays the view image on a display device. The guide line overlapping section overlaps a guide line for assisting a forward parking of the vehicle on the view image. The guide line includes a front end guide line extending from a first position to a second position. The first position is a position obtained by rotationally transferring a position of a rotational outer front end of the vehicle by 90 degrees around a rotational center of the vehicle. The second position is located at a distance of a width of the vehicle from the first position toward a rear in a front-rear direction of the vehicle.

### CROSS REFERENCE TO RELATED APPLICATIONS

The present application is based on and claims priority to Japanese Patent Application No. 2009-251980 filed on Nov. 2, 2009, the contents of which are incorporated in their entirety herein by reference.

### BACKGROUND OF THE INVENTION

1. Field of the Invention

The present invention relates to a vehicle surrounding monitoring device and a method of controlling a vehicle surrounding monitoring device.

2. Description of the Related Art

Conventionally, a method for displaying guide lines for a parking assistance on a rear shot image when a vehicle moves backward is disclosed, for example, in JP-A-H1-14700.

U.S. Pat. No. 6,463,363 (corresponding to JP-A-2000-339598) discloses a method in which tracks of a minimum rotational portion and a maximum rotational portion of a vehicle are estimated as guide lines for restricting a contact with an obstacle, and the estimated tracks are displayed on a front shot image.

The guide lines at a time when the vehicle moves forward as disclosed in U.S. Pat. No. 6,463,363 is not sufficient as guide lines for a forward parking assistance. The reason of above-described issue will be described with reference to FIG. 12 to FIG. 14. When a vehicle 50 moves forward or backward at a low speed with a constant steering angle, if a slip of tires can be ignored, the vehicle 50 rotates around a rotational center 52 that is on a rear wheel axis 51. In present case, a maximum rotation track 54 is a circle that has a radius from an outer front end 53 to the rotational center 52, and a minimum rotation track 56 is a circle that has a radius from the rotational center 52 to an inner rear wheel 55. The vehicle moves in a region between the maximum rotation track 54 and the minimum rotation track 56.

The tracks 54 and 56 are suitable as guide lines for a backward parking assistance. However, the tracks 54 and 56 are not sufficient as guide lines for a forward parking assistance. This is because a driver tries to park the vehicle 50 based on a positional relationship between positions of left and right rear wheels and the guide lines when the vehicle 50 moves backward while a driver tries to park the vehicle 50 based on a positional relationship between positions of left and right front wheels and the guide lines when the vehicle 50 moves forward.

Specifically, when the vehicle 50 moves backward into a bay 59 as shown in FIG. 13, a driver tries to control a movement of the vehicle 50 so that the inner rear wheel 55 and an outer rear wheel 58 move along the maximum rotation track 54 and the minimum rotation track 56. Because the positional relationship between the inner rear wheel 55 and the outer rear wheel 58 is a radiate from the rotational center 52 of the maximum rotation track 54 and the minimum rotation track 56, the positional relationship between the inner rear wheel 55 and the outer rear wheel 57 is easy for the driver to understand intuitively. Thus, the driver can understand intuitively how to control the positional relationship between the inner rear wheel 55 and the outer rear wheel 57 based on the maximum rotation track 54 and the minimum rotation track 56.

When the vehicle 50 moves forward into a bay 59 as shown in FIG. 14, a driver tries to control a movement of the vehicle 50 so that an inner front wheel 60 and an outer front wheel 61 move along the maximum rotation track 54 and the minimum rotation track 56. The positional relationship between the inner front wheel 60 and the outer front wheel 61 is not a radiate from the rotational center 52 of the maximum rotation track 54 and the minimum rotation track 56. This is because the maximum rotation track 54 and the minimum rotation track 56 are drawn in such a manner that the rotational center 52 is on the axis of the inner rear wheel 55 and the outer rear wheel 58. There is a difference between a direction 62 from the rotational center 52 to the inner front wheel 60 and a direction 63 from the rotational center 52 to the outer front wheel 61, and the difference causes a difference in position on circumferences of the maximum rotation track 54 and the minimum rotation track 56. In this way, because a preferable positional relationship between the inner front wheel 60 and the outer front wheel 61 at each time is not radiate from the rotational center 52, the positional relationship is difficult for the driver to understand intuitively. Thus, even when the driver sees the maximum rotation track 54 and the minimum rotation track 56, the driver cannot easily understand how to control the positions of the inner front wheel 60 and the outer front wheel 61 along the maximum rotation track 54 and the minimum rotation track 56.

### SUMMARY OF THE INVENTION

In view of the foregoing problems, it is an object of the present invention to provide a vehicle surrounding monitoring device and a method of controlling a vehicle surrounding monitoring device that can display an appropriate guide line at a forward parking.

Another object of the present invention is to provide a vehicle surrounding monitoring device and a method of controlling a vehicle surrounding monitoring device in which images are displayed so that an occupant can easily see the whole images.

According to a first aspect of the present invention, a vehicle surrounding monitoring device for assisting a forward parking of a vehicle includes an image display control section and a guide line overlapping section. The image display control section is configured to make a view image based on a shot image that is shot by a camera for shooting a surrounding of the vehicle. The image display control section is configured to display the view image on a display device disposed in the vehicle. The guide line overlapping section is configured to overlap a guide line for assisting the forward parking of the vehicle on the view image. The guide line includes a front end guide line. The front end guide line is a straight line extending from a first position to a second position. The first position is a position obtained by rotationally transferring a position of a rotational outer front end of the vehicle by 90 degrees around a rotational center of the vehicle. The second position is located at a distance of a width of the vehicle from the first position toward a rear in a front-rear direction of the vehicle.

The front end guide line corresponds to a position of a front end of the vehicle at a time when the vehicle moves forward while keeping a steering angle and a posture of the vehicle is rotated 90 degrees around the rotational center from the current posture. Because the vehicle surrounding monitoring device according to the first aspect overlaps the front end guide line on the view image, a driver can easily understand a position where to start moving the vehicle forward with the steering angle in order to park the vehicle in a bay by confirming a positional relationship between the bay and the front end guide line.

According to a second aspect of the present invention, a vehicle surrounding monitoring device includes an image display control section. The image display control section is configured to make a left view image based on a side shot image shot by a side camera for shooting a left of a vehicle, a right view image based on a side shot image shot by a side camera for shooting a right of the vehicle, and a top view image viewed from above the vehicle. The image display control section is configured to simultaneously display the left view image, the top view image, and the right view image on a display device disposed in the vehicle. The left view image is displayed in a first display section, the top view image is displayed in a second display section, and the left view image is displayed in a third display section. The ratio of areas of the first display section, the second display section, and the third display section is variable.

In the vehicle surrounding monitoring device according to the second aspect, the left view image, the right view image, and the top view image are simultaneously displayed. Thus, an occupant can easily see the whole image. Furthermore, because the ratio of the areas of display sections is variable, the view images can be displayed flexibly to the situation.

According to a third aspect of the present invention, in a method of controlling a vehicle surrounding monitoring device that assists a forward parking of a vehicle, a view image is made based on an image short by a camera for shooting a surrounding of the vehicle, the view image is displayed on a display device disposed in the vehicle, and a guide line for assisting the forward parking of the vehicle is overlapped on the view image. The guide line includes a front end guide line. The front end guide line is a straight line extending from a first position to a second position. The first position is a position obtained by rotationally transferring a position of a rotational outer front end of the vehicle by 90 degrees around a rotational center of the vehicle. The second position is located at a distance of a width of the vehicle from the first position toward a rear in a front-rear direction of the vehicle.

The front end guide line corresponds to a position of a front end of the vehicle at a time when the vehicle moves forward while keeping a steering angle and a posture of the vehicle is rotated 90 degrees around the rotational center from the current posture. In the method according to the third aspect, the front end guide line is overlapped on the view image. Thus, a driver can easily understand a position where to start moving the vehicle forward with the steering angle in order to park the vehicle in a bay by confirming a positional relationship between the bay and the front end guide line.

The method according to the third aspect may be included in instructions of a program product stored in a computer readable storage medium for execution by a computer.

According to a fourth aspect of the present invention, in method of controlling a vehicle surrounding monitoring device, a left view image is made based on a side shot image shot by a side camera for shooting a left of a vehicle, a right view image is made based on a side shot image shot by a side camera for shooting a right of the vehicle, a top view image viewed from above the vehicle is made, and the left view image, the right view image, and the top view image are simultaneously displayed on a display device disposed in the vehicle. The left view image is displayed in a first display section, the top view image is displayed in a second display section, and the left view image is displayed in a third display section. The ratio of areas of the first display section, the second display section, and the third display section is variable.

In the method according to the fourth aspect, the left view image, the right view image, and the top view image are simultaneously displayed. Thus, an occupant can easily see the whole images. Furthermore, because the ratio of the areas of the display sections is variable, the view images can be displayed flexibly to the situation.

The method according to the third aspect may be included in instructions of a program product stored in a computer readable storage medium for execution by a computer.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a block diagram showing a forward parking assist system according to an embodiment of the present invention;

FIG. 2 is a diagram showing positions of a front camera, a rear camera, a right camera, a left camera, and a display device disposed on a vehicle;

FIG. 3 is a flowchart showing a forward parking assist process performed by an image synthesizing ECU;

FIG. 4 is a diagram showing an exemplary position of a vehicle when a forward parking assist is started;

FIG. 5 is a diagram showing a minimum rotation track and a maximum rotation track;

FIG. 6 is a diagram showing a front end guide line, a side guide line, and track guide lines;

FIG. 7 is a diagram showing a relationship among the front end guide line, the side guide line, and a virtual position of the vehicle;

FIG. 8 is a diagram showing a left display section, a top display section, and a right display section;

FIG. 9 is a diagram showing examples of the left view image, the top view image, and the right view image;

FIG. 10 is a diagram showing a front end guide line, a side guide line, and track guide lines overlapped on a front view image;

FIG. 11 is a diagram showing a front end guide line, a side guide line, and track guide lines overlapped on a left view image obtained from a left shot image without extraction;

FIG. 12 is a diagram showing a maximum rotation track and a minimum rotation track of a vehicle according to a prior art;

FIG. 13 is a diagram showing a movement of the vehicle at a backward parking; and

FIG. 14 is a diagram showing a movement of the vehicle at a forward parking.

### DETAILED DESCRIPTION OF THE PREFERRED EMBODIMENTS

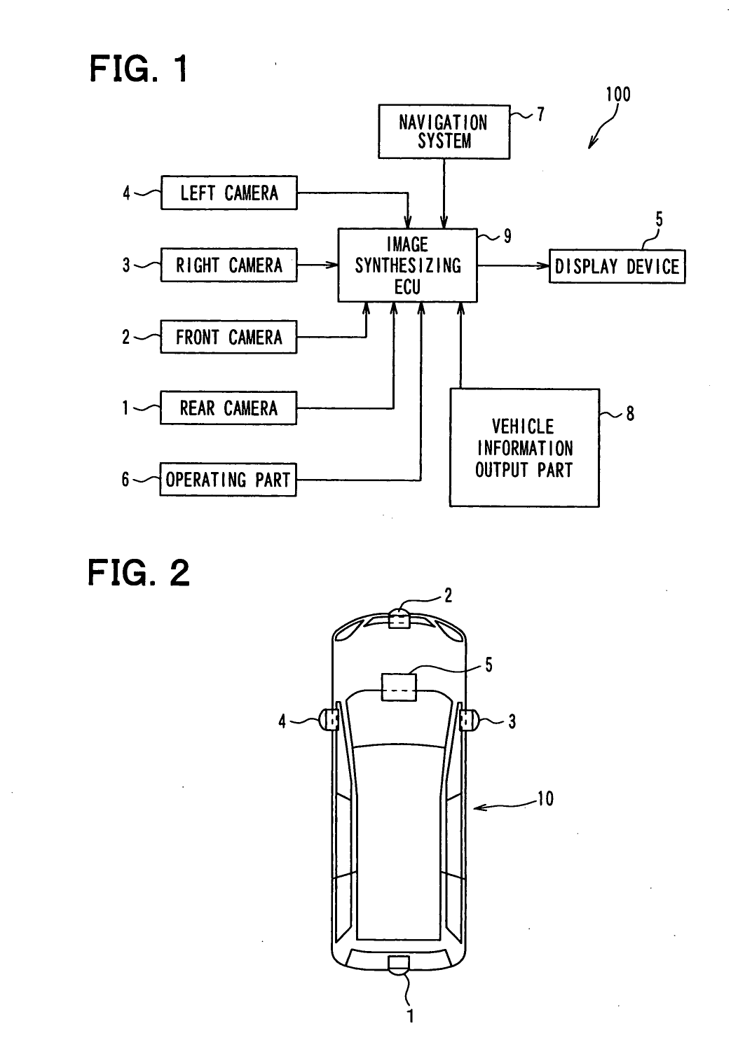

A forward parking assist system 100 according to an exemplary embodiment of the present invention will be described with reference to FIG. 1 and FIG. 2. The forward parking assist system 100 is mounted on a vehicle 10. The forward parking assist system 100 includes a rear camera 1, a front camera 2, a right camera 3, a left camera 4, a display device 5, an operating part 6, a navigation system 7, a vehicle information output part 8, and an image synthesizing ECU 9. In the following description, upper, lower, right, left, front, and rear respectively mean upper, lower, right, left, front and rear based on a direction of the vehicle 10 unless otherwise stated.

The rear camera 1 is a wide angle camera. The rear camera 1 is attached to a rear end portion of the vehicle 10. The rear camera 1 repeatedly shoots images of the rear of a rear end of the vehicle 10 and successively outputs rear shot images to the image synthesizing ECU 9.

The front camera 2 is a wide angle camera. The front camera 2 is attached to a front end portion of the vehicle 10. The front camera 2 repeatedly shoots images of the front of a front end of the vehicle 10 and successively outputs front shot images to the image synthesizing ECU 9.

The right camera 3 is attached to a right side of the vehicle 10. For example, the right camera 3 may be attached to a lower end portion of a right fender mirror. The right camera 3 repeatedly shoots images of the right of the vehicle 10 and successively outputs right shot images to the image synthesizing ECU 9. The right camera 3 is a wide angle camera whose shooting area includes the diagonally forward right, the right, and the diagonally backward right of the vehicle 10.

The left camera 4 is attached to a left side of the vehicle 10. For example, the left camera 4 may be attached to a lower end portion of a left fender mirror. The left camera 4 repeatedly shoots images of the left of the vehicle 10 and successively outputs left shot images to the image synthesizing ECU 9. The left camera 4 is a wide angle camera whose shooting area includes the diagonally forward left, the left, and the diagonally backward left of the vehicle 10.

The display device 5 is disposed in the vehicle 10 and displays images to an occupant of the vehicle 10. The display device 5 may be disposed, for example, at a center portion of an instrument panel in a vehicle interior.

The operating part 6 includes a device, such as a push button, operated by an occupant of the vehicle 10. The operating part 6 outputs a signal to the image synthesizing ECU 9 in accordance with operations.

The navigation system 7 specifies the present location of the vehicle 10 based on an output from a position detecting device such as a GPS receiver (not shown) and displays a map image around the present location. The navigation system 7 also calculates an optimum route from the present location to a destination input by an occupant and performs a route guidance of the calculated route. The navigation system 7 includes map data used for displaying the map image, calculating the optimum route, and performing the route guidance. The map data includes location information of parking lots. When the navigation system 7 receives a signal requesting the present location from the image synthesizing ECU 9, the navigation system 7 specifies the present location and outputs a specified result to the image synthesizing ECU 9. When the navigation system 7 receives an inquiry whether the vehicle 10 is in a parking lot from the image synthesizing ECU 9, the navigation system 7 determines whether the vehicle 10 is in a parking lot based on the location information the parking lots included in the map data and the present location of the vehicle 10 and outputs a determined result to the image synthesizing ECU 9.

The vehicle information output part 8 receives information about operation of the vehicle 10 from various sensors in the vehicle 10 and outputs the received information to the image synthesizing ECU 9. The information includes information on a shift position or a drive position of the vehicle 10, information on operating state of directional indicators of the vehicle 10, information on a speed of the vehicle 10, and information on a steering angle of the vehicle 10. In the present specification, a steering angle at a position where the vehicle 10 goes straight, that is, a steering angle at a straight position is set to 0 degree. In both cases where a steering wheel is turned to the right and the steering wheel is turned to the left, the steering angle is a positive value.

The image synthesizing ECU 9 can function as a vehicle surrounding monitoring device. The image synthesizing ECU 9 successively receives the rear shot images output from the rear camera 1, the front shot images output from the front camera 2, the right shot images output from the right camera 3, and the left shot images output from the left camera 4. Every time the image synthesizing ECU 9 receives a new group of the front shot image, the right shot image, and the left shot image, the image synthesizing ECU 9 synthesizes the three images and displays the synthesized image on the display device 5.

The image synthesizing ECU 9 may be a microcomputer including a central processing unit (CPU), a random access memory (RAM), a read only memory (ROM) and a flash memory. The CPU executes a program stored in the ROM so as to perform a desired process. During the process, as necessary, the CPU reads information from the RAM, the ROM, and the flash memory, stores information in the flash memory, receives information from, the cameras 1-4, the operating part 6, navigation system 7, and the vehicle information output part 8, and outputs signals to the display device 5 and the navigation system 7. The ROM in the image synthesizing ECU 9 stores various information including a width W, a length L, and a wheel base A of the vehicle 10.

The ROM in the image synthesizing ECU 9 also stores a map that indicates a correspondence relationship between various steering angles and a rotation radius Ri of an inner rear wheel in a case where the vehicle 10 moves forward at a low speed while maintaining the steering angle. At a right rotation, the inner rear wheel is a right rear wheel. At a left rotation, the inner rear wheel is a left rear wheel.

The ROM in the image synthesizing ECU 9 also stores a map that indications a correspondence relationship between various steering angles and a rotation radius Ro of an outer front end of the vehicle 10 in a case where the vehicle 10 moves forward at a low speed while maintaining the steering angle. At a right rotation, the outer front end is a left front end. At a left rotation, the outer front end is a right front end.

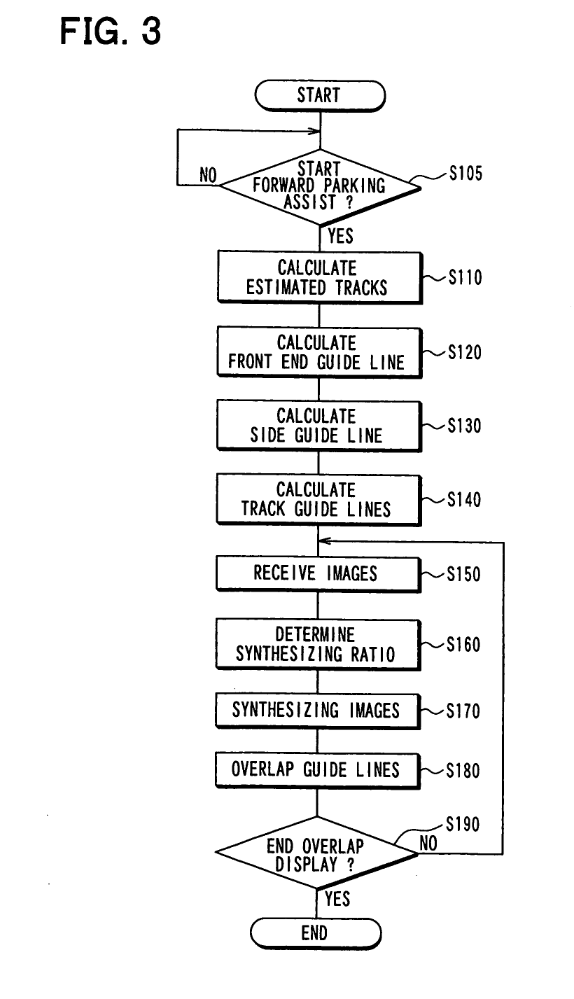

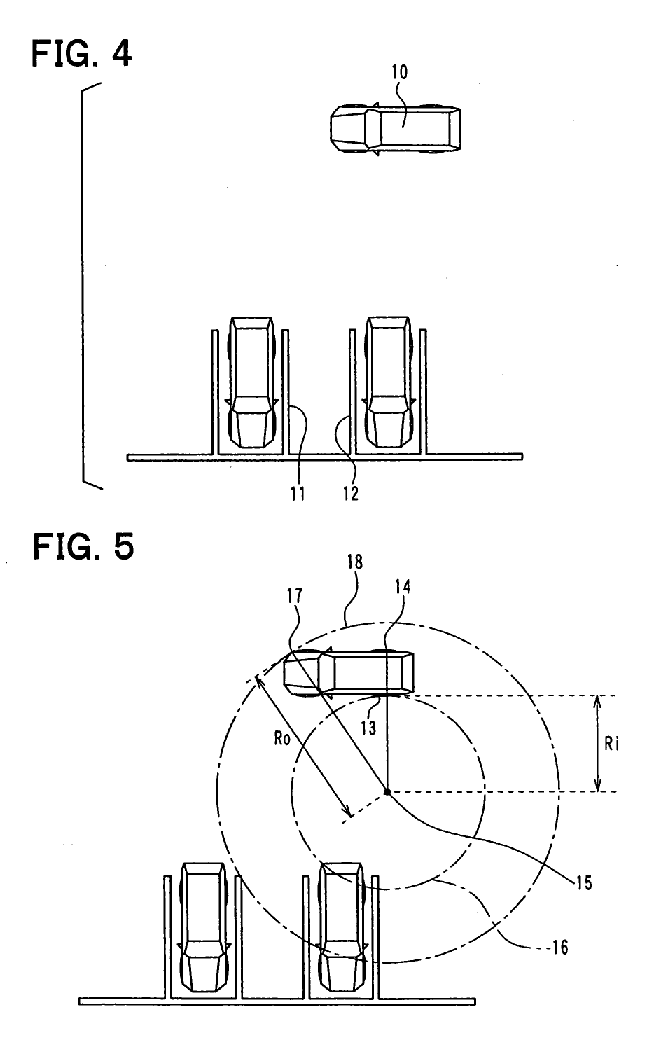

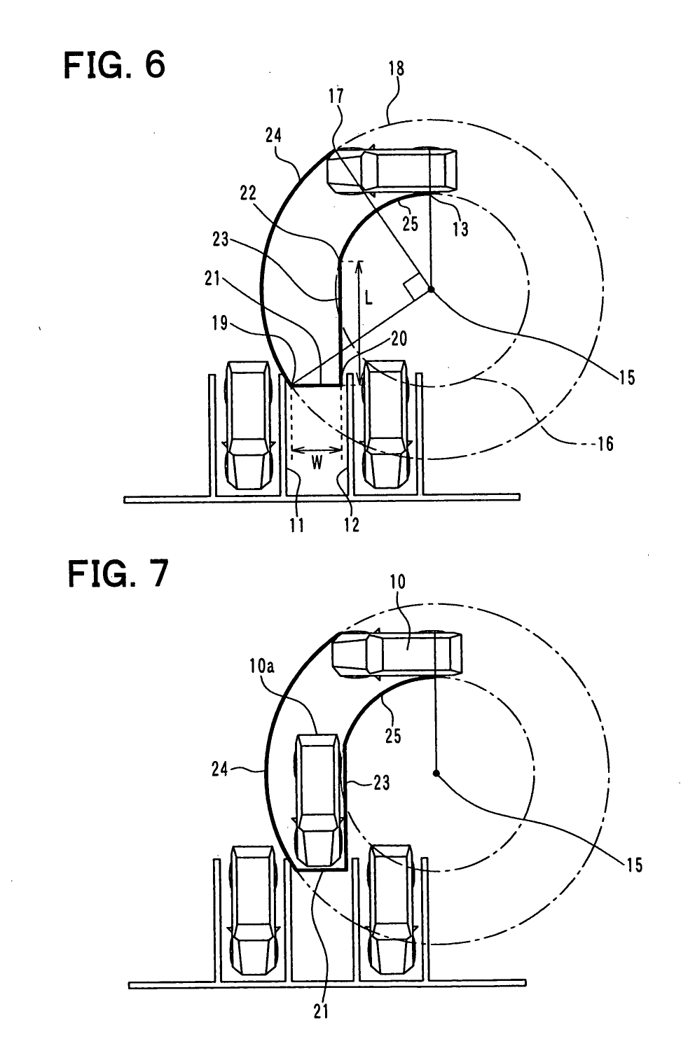

A forward parking assist process performed by the image synthesizing ECU 9 will be described with reference to FIG. 3. The image synthesizing ECU 9 is activated when an engine or a motor of the vehicle 10 is activated, and the image synthesizing ECU 9 starts to execute the forward parking assist process.

At S105, the image synthesizing ECU 9 determines whether to start a forward parking assist. When the image synthesizing ECU 9 determines not to start the forward parking assist, which corresponds to “NO” at S105, the image synthesizing ECU 9 repeats the determination at S105. When the image synthesizing ECU 9 determines to start the forward parking assist, which corresponds to “YES” at S105, the process proceeds to S110.

The image synthesizing ECU 9 may determine to start the forward parking assist, for example, when an occupant pushes a parking assist start button in the operating part 6. An occupant may push the parking assist start button, for example, when the vehicle 10 is placed perpendicularly to a parking direction of a bay between parking lines 11 and 12 in order to move the vehicle 10 forward and park the vehicle 10 in the bay.

In the present embodiment, the operating part 6 includes a parking assist start button for right rotation and a parking assist start button for left rotation. When one of the two parking assist start buttons is pushed, the image synthesizing ECU 9 determines to start the forward parking assist at S105 and the process proceeds to S110.

In the following description, a case where the parking assist start button for left rotation is pushed will be described. In a case where the parking assist start button for right rotation is pushed, directions of operations are reversed in a left-right direction.

At S110, the image synthesizing ECU 9 calculates an estimated track of a minimum rotating portion, that is, an inner rear wheel 13 and an estimated track of a maximum rotating portion, that is, the outer front end 17 in a case where the vehicle 10 moves forward at a low speed with the steering angle being the maximum to the left. The estimated track of the inner rear wheel 13 is called a minimum rotation track 16. The estimated track of the outer front end 17 is called a maximum rotation track 18.

A rotational center 15 of the minimum rotation track 16 and the maximum rotation track 18 is on an axis of the inner rear wheel 13 and an outer rear wheel 14. A distance between the rotational center 15 and the inner rear wheel 13 is the inner rear wheel rotation radius Ri in a case where the steering angle is the maximum to the left. A distance between the rotational center 15 and the outer front end 17 is the outer front end rotation radius Ro in a case where the steering angle is the maximum to the left. The image synthesizing ECU 9 calculates the inner rear wheel rotation radius Ri and the outer front end rotation radius Ro based on the map stored in the ROM.

The positions of the minimum rotation track 16 and the maximum rotation track 18 are, expressed as coordinates on a ground in a coordinate system fixed to the vehicle 10. In other words, the positions of the minimum rotation track 16 and the maximum rotation track 18 are calculated as relative positions to the vehicle 10. Positions of a front end guide line, a side guide line, and track guide lines described below are also calculated as relative positions to the vehicle 10.

At S120, the image synthesizing ECU 9 calculates a front end guide line 21. In order to calculate the front end guide line 21, the image synthesizing ECU 9 calculates a position 19 that is obtained by rotationally transferring a position of the outer front end 17 of the vehicle 10 at a time when the process at S110 is executed by 90 degrees counterclockwise around the rotational center 15. The position 1.9 corresponds to an example of a first position. Then, the image synthesizing ECU 9 calculates a position 20 that is at a distance of the width W of the vehicle 10 from the position 19 toward a rear in the front-rear direction of the vehicle 10. The width W is stored in the ROM. The position 20 corresponds to an example of a second position. Then, a straight line extending from the position 19 to the position 20 is decided as the front end guide line 21.

In FIG. 7, the front end guide line 21 is compared with a virtual position 10a of the vehicle 10. The virtual position 10a is a position of the vehicle 10 in a case where the vehicle 10 moves forward at a low speed from the present position in a state where the steering angle is the maximum to the left and the posture of the vehicle 10 is rotated 90 degrees counterclockwise with respect to the present posture. As shown in FIG. 7, the front end guide line 21 is calculated so as to correspond to a front end of the vehicle 10 at the virtual position 10a.

If the front end guide line 21 is displayed to an occupant of the vehicle 10, the occupant easily understand a position of the front end of the vehicle 10 at a time when the vehicle moves forward at a low speed in a state where the steering angle is the maximum to the left and the posture of the vehicle 10 is rotated 90 degrees counterclockwise with respect to the present posture, that is, at a time when side surfaces of the vehicle 10 are parallel to the parking lines 11 and 12.

At S130, the image synthesizing ECU 9 calculates a side guide line 23. In order to calculate the side guide line 23, the image synthesizing ECU 9 calculates a position 22 that is at a distance of the length L of the vehicle 10 from the position 20 in the right direction of the vehicle 10. In other words, the position 22 is away from the position 20 toward the vehicle 10 in a left-right direction of the vehicle 10.

The position 22 corresponds to an example of a third position. Then, a straight line extending from the position 20 to the position 22 is decided as the side guide line 23.

In FIG. 7, the side guide line 23 is compared with the virtual position 10a of the vehicle 10. The side guide line 23 corresponds to the left surface of the vehicle 10 at the virtual position 10a.

If the side guide line 23 is displayed to an occupant of the vehicle 10, the occupant easily understand a position of the left side of the vehicle 10 at a time when the vehicle moves forward at a low speed in a state where the steering angle is the maximum to the left and the posture of the vehicle 10 is rotated 90 degrees counterclockwise with respect to the present posture, that is, at a time when the side surfaces of the vehicle 10 are parallel to the parking lines 11 and 12.

At S140, the image synthesizing ECU 9 calculates the track guide lines 24 and 25. The track guide line 24 is calculated as an arc extending from the current position of the outer front end 17 to the position 19 along the maximum rotation track 18. The track guide line 24 corresponds to an example of a rotational outer track guide line. The track guide line 25 is calculated as an arc extending from the current position of the inner rear wheel 13 to the position 22 along the minimum rotation track 16. The track guide line 25 corresponds to an example of a rotational inner track guide line.

The track guide lines 24 and 25 are provided as lines for confirming whether an obstacle exists on the way when the vehicle 10 moves forward rather than lines for confirming a positional relationship between the bay and the vehicle 10. When an obstacle is in an area surrounded by the track guide lines 24 and 25, the front end guide line 21, and the side guide line 23, if the vehicle 10 moves forward at a low speed in a state where the steering angle is the maximum to the left, the vehicle 10 may collide with the obstacle.

The image synthesizing ECU 9 repeats processes from S150 to S180, for example, with a period of 1/30 seconds until the image synthesizing ECU 9 determines to end an overlap display at S190. At S150, the image synthesizing ECU 9 receives the rear shot image, the front shot image, the right shot image, and the left shot image from the rear camera 1, the front camera 2, the right camera 3, and the left camera 4, respectively. After the image synthesizing ECU 9 receives the shot images, the process proceeds to S160.

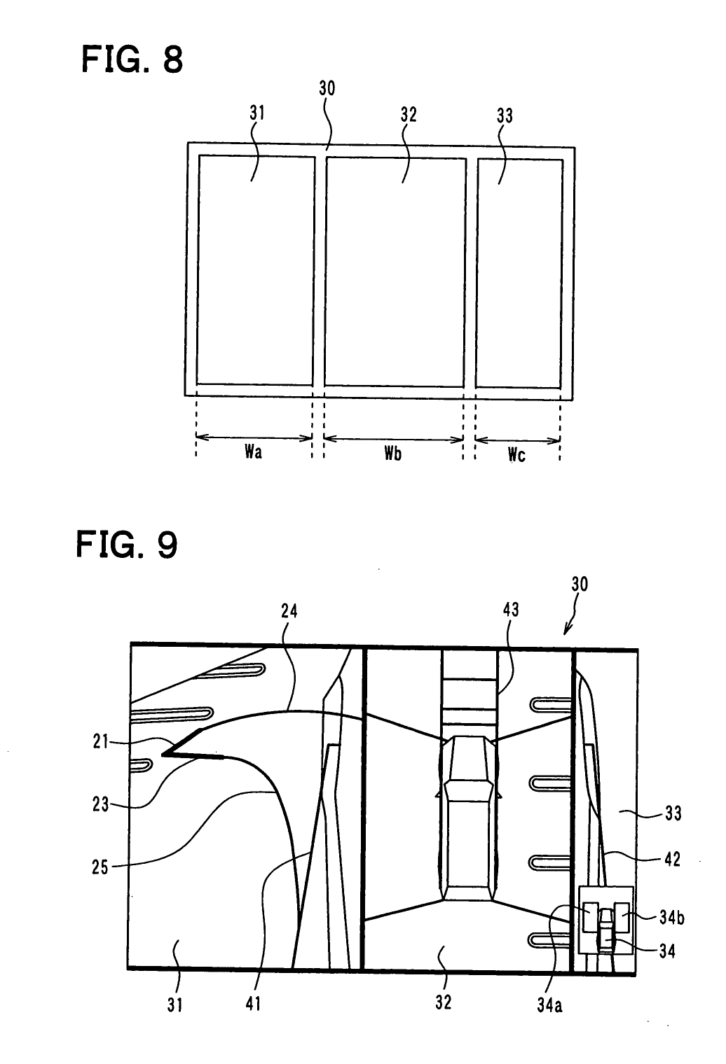

At S160, the image synthesizing ECU 9 determines a synthesizing ratio. As shown in FIG. 8, the synthesizing ratio is a ratio of a width Wa of a left display section 31, a width Wb of a top display section 32, and a width Wc of a right display section 33 in a screen 30 of the display device 5. In the left display section 31, a left view image is displayed. In the top display section 32, a top view image is displayed. In the right display section 33, a right view image is displayed. Because heights of the display sections 31-33 in the screen 30 are the same, the synthesizing ratio is a ratio of areas of the display sections 31-33 as well as the ratio of the widths of the display sections 31-33.

The left view image is made by extracting only a portion including an image of the diagonally forward left from the left shot image and treating the extracted portion, for example, with a distortion compensation. The right view image is made by extracting only a portion including an image of the diagonally forward right from the left shot image and treating the extracted portion, for example, with a distortion compensation. The top view image is a virtual image viewed from above the vehicle 10 and is made based on the rear shot image, the front shot image, the left shot image, the right shot image, and an image of the vehicle 10 stored in the ROM. In the top view image, the front end of the vehicle 10 faces upward in the screen 30.

The image synthesizing ECU 9 determines the synthesizing ratio based on the steering angle at a time when the process at S160 is executed. When the steering angle is at the straight position, the width Wa of the left display section 31 is the same as the width Wc of the right display section 33. At the present time, the width Wb of the top display section 32 may be determined optionally.

When the steering wheel is turned to the left from the straight position, a ratio Wa/Wc of the width Wa of the left display section 31 with respect to the width Wc of the right display section 33 and a ratio Wa/Wb of the width Wa of the left display section 31 with respect to the width Wb of the top display section 32 increases with the steering angle and the ratio Wa/Wc is greater than 1.

When the steering wheel is turned to the right from the straight position, a ratio Wc/Wa of the width Wc of the right display section 33 with respect to the width Wa of the left display section 31 and a ratio Wc/Wb of the width Wc of the right display section 33 with respect to the width Wb of the top display section 32 increases with the steering angle and the ratio Wc/Wa is greater than 1.

The width Wb of the top display section 32 may be constant regardless of the steering angle.

At S170, the image synthesizing ECU 9 synthesizes the images based on the synthesizing ratio determined at S160. The synthesized image is displayed on the screen 30 of the display device 5 as shown in FIG. 9.

By changing the ratio of areas or widths of the display sections 31-33 based on a driving operation by a driver, the image synthesizing ECU 9 can perform a flexible process, such as expanding a required portion, in accordance with a driving state.

Specifically, at S170, the left view image made by treating the left shot image with the extraction and the distortion compensation is displayed in the left display section 31 of the screen 30. A left side portion of the left view image is deleted in accordance with the width Wa of the left display section 31. In other words, as the width Wa of the left display section 31 is decreased, an area of the left side portion which is deleted is increased.

In addition, the right view image made by treating the right shot image with the extraction and the distortion compensation is displayed in the right display section 33 of the screen 30. A right side portion of the right view image is deleted in accordance with the width Wc of the right display section 33. In other words, as the width Wc of the right display section 33 is decreased, an area of the right side portion which is deleted is increased.

The image synthesizing ECU 9 treats the rear shot image, the front shot image, the left shot image, and the right shot image with a known viewpoint conversion to a bird's eye image, that is, an image viewed from above the vehicle 10. Then, the image synthesizing ECU 9 combines the converted image with the image of the vehicle 10 stored in the ROM to make the top view image. The top view image is displayed in the top display section 32 of the screen 30. A method of the viewpoint conversion to the image viewed from above the vehicle 10 is disclosed, for example, in JP-A-4-163249.

On the left view image and the right view image, parts 41 and 42 of rectangular lines expanding from an outer periphery of the vehicle 10 by from 10 cm to 30 cm may be overlapped. On the top view image, a ladder-shaped line 43 may be overlapped so as to provide a sense of distance in front of the vehicle 10 to a driver. At a right lower portion of the display section 33, an image 34 indicating an extracted area 34a of the left view image and an extracted area 34b of the right view image may be displayed.

The left view image, the right view image, and the top view image are simultaneously displayed on the screen 30. In addition, the left view image, the top view image, and the right view image are arranged from the left to the right. Thus, an occupant can easily see the whole images.

The front end of the vehicle 10 in the top view image is arranged at a position lower than a right end of the track guide line 24, that is, an end of the track guide line 24 adjacent to the top view image so that a balance of displaying the top view image and the left view image looks natural to an occupant.

At S180, the image synthesizing ECU 9 overlaps the guide lines on the images that is synthesized at S170 and is displayed on the display device 5. In the present case, the image synthesizing ECU 9 overlaps the front end guide line 21, the side guide line 23, and the track guide lines 24 and 25 calculated in the process from S120 to S140 on the left view image in the screen 30.

The front end guide line 21, the side guide line 23, the track guide lines 24 and 25 are calculated as coordinates on the ground in the coordinate system fixed to the vehicle 10 at the present position. When the front end guide line 21, the side guide line 23, and the track guide lines 24 and 25 are overlapped on the left view image, the image synthesizing ECU 9 treats position coordinates of the front end guide line 21, the side guide line 23, the track guide lines 24 and 25 on the ground with an inversion conversion of the viewpoint conversion from the left shot image to the top view image. Then, the image synthesizing ECU 9 overlaps the front end guide line 21, the side guide line 23, and the track guide lines 24 and 25 on the left view image.

At S190, the image synthesizing ECU 9 determines whether to end the overlap display of the front end guide line 21, the side guide line 23, and the track guide lines 24 and 25. The image synthesizing ECU 9 may determine to end the overlap display, for example, when the steering angle changes from angle other than the straight position to the straight position. The image synthesizing ECU 9 may also determine to end the overlap display when the driving position of the vehicle 10 is at a parking position, that is, when the vehicle 10 is stopped. The image synthesizing ECU 9 may also determine to end the overlap display when an ignition switch of the vehicle 10 is turned off. The image synthesizing ECU 9 may also determine to end the overlap display when the posture of the vehicle 10 is rotated 90 degrees from a posture at the last time the image synthesizing ECU 9 executes the process at S110, that is, from a posture at a time when the image synthesizing ECU 9 starts the overlap display. When the image synthesizing ECU 9 determines to end the overlap display, which corresponds to “YES” at S190, the image synthesizing ECU 9 deletes the front end guide line 21, the side guide line 23, and the track guide lines 24 and 25 from the left view image. Then, the image synthesizing ECU 9 ends the forward parking assist process shown in FIG. 3. When the image synthesizing ECU 9 determines not to end the overlap display, the process returns to S150.

Even after the image synthesizing ECU 9 determines to end the overlap display at S190, the image synthesizing ECU 9 may repeat the process from S150 to S170 so as to display the view images on the screen 30 of the display device 5. In the present case, a time when the display of the view images ends is different from a time when the overlap display of the guide lines 21, 23-35 ends.

In the present case, the image synthesizing ECU 9 may determine to end the overlap display at S190 when a predetermined time (e.g., 5 seconds) has elapsed since the image synthesizing ECU 9 executes the process S110, that is, since the image synthesizing ECU 9 starts the overlap display.

As described above, when a driver starts to a forward parking of the vehicle 10 into a bay, the driver operates the vehicle 10 so that the vehicle 10 approaches the bay and the forward-rear direction of the vehicle 10 becomes at 90 degrees with respect to the parking direction of the bay. Then, the driver pushes the parking assist start button for right rotation or the parking assist start button for left rotation based on a position of the bay with respect of the vehicle 10. For example, when the bay is positioned to the left of the vehicle 10, the driver pushes the parking assist start button for left rotation.

Then, the image synthesizing ECU 9 executes the forward parking assist process from S110 to S180 once, and the front end guide line 21, the side guide line 23, and the track guide lines 24 and 25 are overlapped on the left view image as shown in FIG. 9.

As described above, the front end guide line 21 is the position of the front end of the vehicle 10 at a time when the vehicle 10 moves forward at a low speed in a state where the steering angle is the maximum to the left and the posture of the vehicle 10 is rotated 90 degrees counterclockwise from the present posture. Thus, the driver can determine whether the vehicle 10 can be parked in the bay appropriately in a case where the vehicle 10 moves forward with the maximum steering angle by confirming a positional relationship between the front end guide line 21 and the bay displayed on the screen 30.

After that, the driver moves the vehicle 10 straight forward or straight backward for a fine adjustment. Until the image synthesizing ECU 9 determines to end the overlap display at S190, the process from S150 to S180 is repeated. Thus, in accordance with the movement of the vehicle 10, scenery in the left view image changes. Because the relative positions of the front end guide line 21, the side guide line 23, and the track guide lines 24 and 25 with respect the vehicle 10 do not change, the positions of the front end guide line 21, the side guide line 23, and the track guide lines 24 and 25 in the left view image do not change. Thus, in the left view image, positions of the scenery overlapped with the front end guide line 21, the side guide line 23, and the track guide lines 24 and 25 change in accordance with the movement of the vehicle 10.

The driver adjusts the position of the vehicle 10 so that the front end guide line 21 enters the bay. The driver can also use the side guide line 23 as a supplementary line of the front end guide line 21 for confirming the positional relationship between the vehicle 10 and the parking line 12. In addition, the driver can confirm whether the vehicle 10 can be parked in the bay without coming in contact with an obstacle by confirming whether an obstacle does not exist in an area surrounded by the front end guide line 21, the side guide line 23, and the track guide lines 24 and 25.

When the front end guide line 21 enters the bay, the driver turns the steering wheel to the left to the maximum and moves the vehicle 10 forward at a low speed. While the vehicle 10 moves forward, the front end guide line 21 and the side guide line 23 are useless. When the driver moves the vehicle 10 forward in a state where the steering angle is the maximum to the left without concerning about the front end guide line 21 and the side guide line 23, the vehicle 10 automatically moves to the virtual position 10a as shown in FIG. 7. After that, the driver returns the steering angle to the straight position and the moves the vehicle 10 straight forward, and thereby the vehicle 10 is fitted into the bay.

In a case where the image synthesizing ECU 9 is configured to determine to end the overlap display at S190 when the predetermined time (e.g., 5 seconds) has elapsed since the image synthesizing ECU 9 starts the overlap display, the front end guide line 21, the side guide line 23, and the track guide lines 24 and 25 are displayed for a short time. Thus, the front end guide line 21, the side guide line 23, and the track guide lines 24 and 25 may disappear while the driver is adjusting the position of the vehicle 10. In such a case, the overlap display can be restarted by pushing the parking assist start button. Even when the front end guide line 21, the side guide line 23, and the track guide lines 24 and 25 disappear just after the adjustment of the position of the vehicle 10 ends, because all the driver has to do is move the vehicle 10 forward at a low speed in a state where the steering angle is the maximum to the left, no inconvenience is caused.

In this way, the image synthesizing ECU 9 overlaps the front end guide line 21 and the side guide line 23 on the view image. Thus, when the vehicle 10 is parked forward, a driver can easily understand a position where to start moving the vehicle 10 forward with the maximum steering angle.

### Other Embodiments

Although the present invention has been fully described in connection with the exemplary embodiments thereof with reference to the accompanying drawings, it is to be noted that various changes and modifications will become apparent to those skilled in the art.

For example, in the above-described embodiment, the front end guide line 21, the side guide line 23, and the track guide lines 24 and 25 are the front end of the vehicle 10 at a time when the posture of the vehicle 10 is rotated 90 degrees, the inner side of the vehicle 10 at a time when the posture of the vehicle 10 is rotated 90 degrees, and parts of the maximum rotation track and the minimum rotation track, respectively, in a case where the vehicle 10 moves forward with the maximum steering angle to the left or right. In other words, in the above-described embodiment, the front end guide line 21, the side guide line 23, and the track guide lines 24 and 25 are guide lines under the assumption that the steering angle is the maximum to the left or right.

The front end guide line 21, the side guide line 23, and the track guide lines 24 and 25 may also be calculated based on, for example, the steering angle at the time. In present case, in the forward parking assist process shown in FIG. 3, the process may also return to S110 instead of S150 when the image synthesizing ECU 9 determines not to end the overlap display at S190. In such a case, the positions of the front end guide line 21, the side guide line 23, and the track guide lines 24 and 25 in the left view image or the right view image change in accordance with a change in the steering angle based on an operation by a driver.

In the present case, by changing the steering angle without moving the vehicle 10, the front end guide line 21 can enter the bay and the side guide line 23 can be parallel to the parking direction of the bay.

At a time the front end guide line 21 enters the bay and the side guide line 23 is parallel to the parking direction of the bay, the driver moves the vehicle 10 forward at a low speed while keeping the steering angle. Then, the vehicle 10 automatically moves to the virtual position 10a. After that, the driver returns the steering angle to the straight position and moves the vehicle 10 straight forward, and thereby the vehicle 10 is fitted into the bay.

The front end guide line 21, the side guide line 23, and the track guide lines 24 and 25 in the left view image or the right view image may also be fixed to the ground instead of the vehicle 10 after the driver pushes a fixing button. In the present case, after the fixing button is pushed, the image synthesizing ECU 9 sequentially calculates a travel distance and an amount of position change based on an in-vehicle sensor including a gyro sensor, an acceleration sensor, a yaw rate sensor, and a vehicle speed sensor. Then, the image synthesizing ECU 9 recalculates the relative positions of the guide lines 21, 23-25 with respect to the vehicle 10 based on the calculated travel distance and the calculated amount of position change under the assumption that the guide lines 21, 23-25 are fixed to the ground. Then, the guide lines 21, 23-25 are overlapped on the left view image or the right view image.

In the present case, at a time when the front end guide line 21 enters the bay after pushing the parking assist start button, the driver pushes the fixing button. Then, the driver turns the steering wheel to the left or right to the maximum and moves the vehicle 10 forward at a low speed. In the left view image or the right view image, the positions of the front end guide line 21, the side guide line 23 change with the ground. Thus, even while the vehicle 10 moves forward, the front end guide line 21 and the side guide line 23 can be useful.

In the above-described embodiment, the operating part 6 includes the parking assist start button for left rotation and the parking assist start button for right rotation. The operating part 6 may also include only one parking assist start button. In the present case, the image synthesizing ECU 9 may perform one of the following processes A-C in the process S110-S140 and S180 after the parking assist start button is pushed at S105.

In the process A, guide lines for right rotation and guide lines for left rotation are overlapped. In other words, at S110 to S140, the image synthesizing ECU 9 calculates the estimated tracks, the front end guide line, the side guide line, and the track guide lines for both of right rotation and left rotation. Then, at S180, the image synthesizing ECU 9 overlaps the front end guide line, the side guide line, and the track guide lines for right rotation on the right view image and overlaps the front end guide line, the side guide line, and the track guide lines for left rotation on the left view image.

In the process B, between the guide lines for right rotation and the guide lines for left rotation, only the guide lines for a side to which the steering wheel is turned first are overlapped. In other words, at S110 to S140, the image synthesizing ECU 9 calculates the estimated tracks, the front end guide line, the side guide line, and the track guide lines for a side to which the steering wheel is turned first. At S180, the image synthesizing ECU 9 overlaps the front end guide line, the side guide line, and the track guide line for the selected side on corresponding one of the left view image and the right view image.

In the process C, firstly, the image synthesizing ECU 9 overlaps the guide lines for a predetermined side. Then, if the steering angle is changed to the opposite side, the image synthesizing ECU 9 overlaps only the guide lines for the opposite side. In other words, at S110 to S140, the image synthesizing ECU 9 calculates the estimated tracks, the front end guide line, the side guide line, and the track guide lines for the predetermined side. At S180, the image synthesizing ECU 9 overlaps the front end guide line, the side guide line, and the track guide lines for the predetermined side on corresponding one of the left view image and the right view image. When the steering angle is changed to the opposite direction before the image synthesizing ECU 9 determines to end the overlap display at S190, the image synthesizing ECU 9 returns the process to S110. Then, at S110 to S140, the image synthesizing ECU 9 calculates the estimated tracks, the front end guide line, the side guide line, and the track guide lines for a side to which the steering angle is changed. At S180, the image synthesizing ECU 9 overlaps the front end guide line, the side guide line, and the track guide lines for the newly selected side.

As another example of a determination criterion to start the forward parking assist at S105, the image synthesizing ECU 9 may determine to start the forward parking assist when the vehicle 10 is in a parking lot and the vehicle speed is less than a predetermined speed (e.g., 10 km/h). In the present case, the image synthesizing ECU 9 outputs an inquire signal to ask whether the vehicle 10 is in a parking lot to the navigation system 7. Then, the image synthesizing ECU 9 determines whether the vehicle 10 is in a parking lot based on an answer from the navigation system 7.

In addition, when the image synthesizing ECU 9 determines to start the forward parking assist at S105, the image synthesizing ECU 9 may, acquire information about the present location from the navigation system 7. Then, the image synthesizing ECU9 may store the acquired present location in the flash memory as a forward parking assist starting point. After that, when the image synthesizing ECU 9 executes the process at S105 again, the image synthesizing ECU 9 may determine to start the forward parking assist in a case where the present location is in the vicinity (e.g., within 10 meters) of the forward parking assist starting point stored in the flash memory.

In a case where the front end guide line 21, the side guide line 23, and the track guide lines 24 and 25 are overlapped on only one of the left view image and the right view image, at S160, the image synthesizing ECU 9 may set the width of the display section of the one of the left view image and the right view image greater than the width of the display section of the other one.

In the above-described embodiment, the synthesizing ratio of the display sections of the left view image, the top vie image, and the right view image is changed with the steering angle. The synthesizing ratio of the display sections may also be changed based on an operation of a lever of a directional indicator of the vehicle 10. For example, when a right turn signal of the vehicle 10 is turned on by an operation by the driver, the image synthesizing ECU 9 may set the width Wc of the right display section 33 to be greater than the width Wa of the left display section 31. When a left turn signal of the vehicle 10 is turned on, the image synthesizing ECU 9 may set the width Wa of the left display section 31 to be greater than the width Wc of the right display section 33. In the present case, one of the left view image and the right view image on which the guide lines 21, 23-25 are overlapped, that is, the view image of the side to which the vehicle 10 is parked can be emphasized.

The image synthesizing ECU 9 may also display the top view image and only one of the right view image and the left view image on which the front end guide line 21, the side guide line 23, and the track guide lines 24 and 25 are overlapped.

In the above-described embodiment, the front end guide line 21 is a solid line, as an example. The front end guide line 21 may also be a dotted line, a dashed line, or a dashed-dotted line. The front end guide line is a line to know whether the vehicle 10 is located at an appropriate position from which the vehicle 10 rotates 90 degrees and enters bay. Thus, although parts including the positions 19 and 20 are required to be overlapped, the other parts are not necessary. In other words, the front end guide line 21 includes at least a straight solid line extending from the position 19 toward the position 20 (not need to reach the position 20) and a straight solid line extending from the position 20 toward the position 19 (not need to reach the position 19).

In addition to the front end guide line 21, an additional line extending from the position 19 or the position 20 so as to extend the front end guide line 21 may also be overlapped. Even in such a case, when a boundary between the additional line and the front end guide line 21 is visible, the front end guide line 21 can keep its function. As an example of a case where the boundary between the additional line and the front end guide line 21 is visible, for example, widths or line types of the front end guide line 21 and the additional line may be different from each other. A mark such as a black dot may also be overlapped at the position 19 or the position 20 at which the front end guide line 21 and the additional line are connected. Another line may also cross at the position 19 or the position 20 at which the front end guide line 21 and the additional line are connected.

In the above-described embodiment, the side guide line 23, and the track guide lines 24 and 25 are solid line, as an example. The side guide line 23, and the track guide lines 24 and 25 may also be another type of line. The side guide line 23 is not necessary. The side guide line 23 is not need to extend to the position 22. For example, the side guide line 23 may also extend from the position 22 to a position shorter than the length L of the vehicle. That is, the third position is not need to be located at a position at a distance of the length L of the vehicle 10 from the second position. The third position may also be located at a position at a distance shorter than the length L from the second position. The track guide lines 24 and 25 are not need to be overlapped on the view image.

In the above-described embodiment, the image synthesizing ECU 9 simultaneously displays the left view image, the right view image, and the top view image on the screen 30. The image synthesizing ECU 9 may also display only one of the left view image or the right view image, on which the front end guide line 21, the side guide line 23, and the track guide lines 24 and 25 are overlapped.

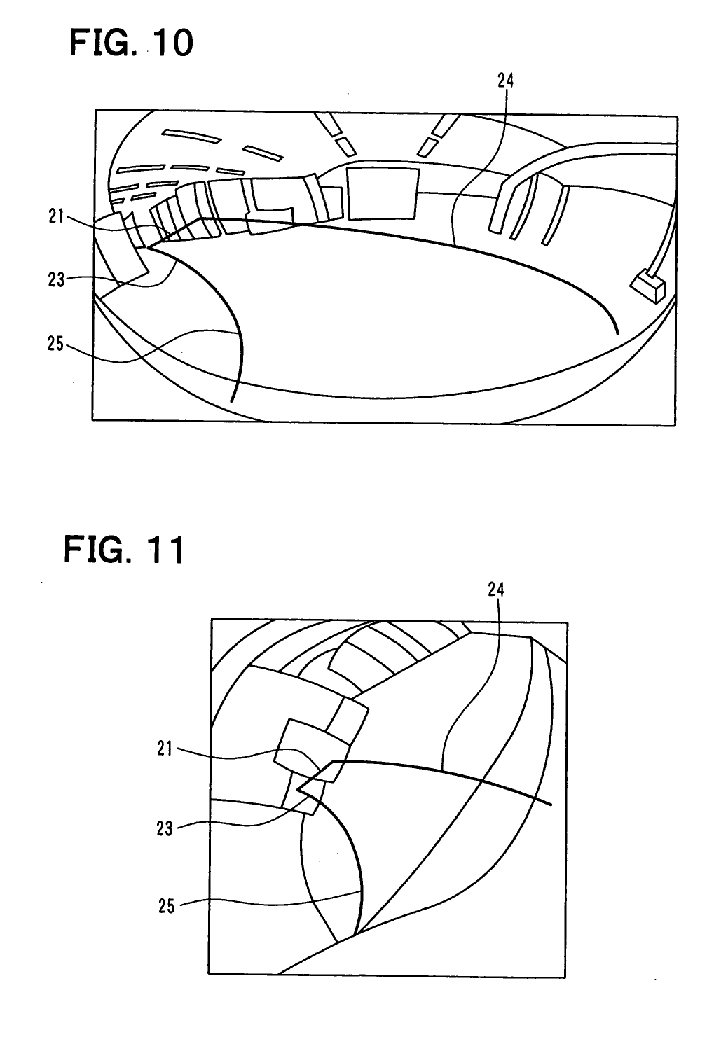

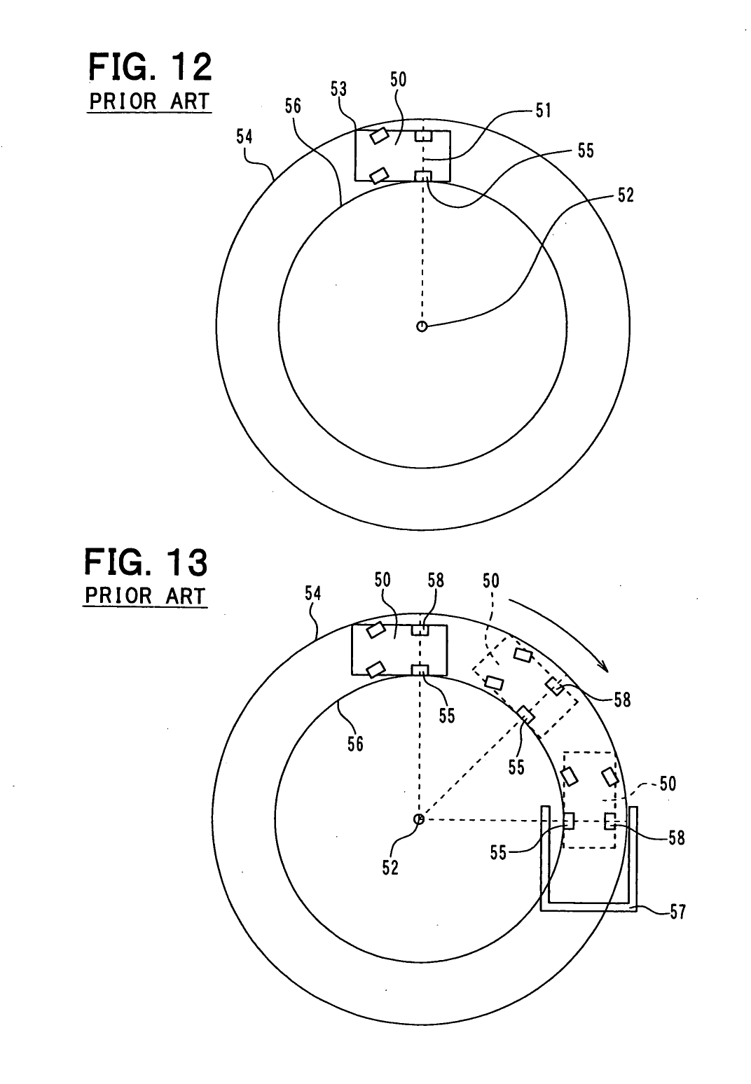

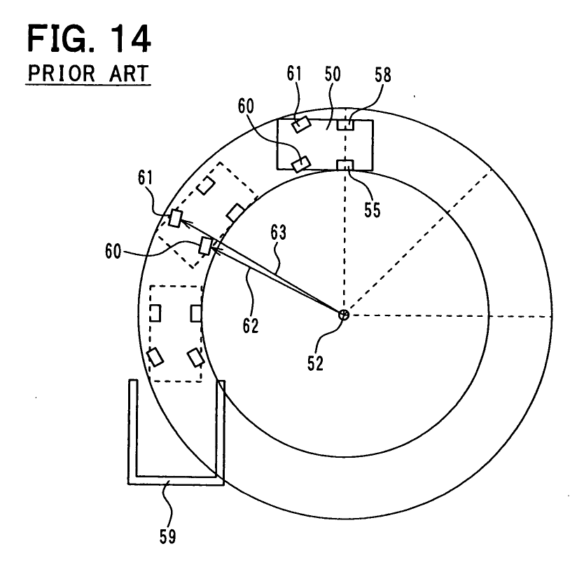

In the above-described embodiment, the front end guide line 21, the side guide line 23, and the track guide lines 24 and 25 are overlapped on one of the left view image and the right view image. As shown in FIG. 10, the image synthesizing ECU 9 may also display only a front view image, not the left view image, the right view image, and the top view image, and may overlap the front end guide line 21, the side guide line 23, and the track guide lines 24 and 25 on the front view image. The front view image is made from only the front shot image shot by the front camera 2 that is a wide angle camera. In other words, the front end guide line 21, the side guide line 23, and the track guide lines 24 and 25 may be overlapped on appropriate positions of the shot image of the surrounding of the vehicle 10.

In a case where an image shot by a wide angle camera is used as a view image without modification, the guide lines 21, 23-25 for left rotation and the guide lines 21, 23-25 for right rotation can be displayed on one image. In a case where the guide lines 21, 23-25 are overlapped on one of the left view image and the right view image made based on an image shot by a narrow angle camera, because a distortion is small, a driver can easily get a sense of distance to the guide lines 21, 23-25.

The left shot image and the right shot image taken by a wide angle camera may also be used as the left view image and the right view image without extraction, and the front end guide line 21, the side guide line 23, and the track guide lines 24 and 25 may also be overlapped on one of the left view image and the right view image as shown in FIG. 11. The image shot by a wide angle camera can have a wide coverage.

In a case where the left view image and the right view image are made by extracting only the diagonally forward left and the diagonally forward right from the shot images and treating the extracted image with the distortion compensation as in the above-described embodiment, because an object treated with the distortion compensation is a part of the image shot by a wide angle camera, distortion of the guide lines 21, 23-25 are small. Thus, a driver can easily get a sense of distance to the guide lines 21, 23-25.

Each function achieved by the image synthesizing ECU 9 by executing program may also be achieved using a hardware having each function. The hardware may include a field programmable gate array (FPGA) whose circuit configuration can be programmed.

It is noted that the flowchart or the processing of the flowchart in the present application includes sections (also referred to as steps), which are represented, for instance, as S105. Further, each section can be divided into several sub-sections while several sections can be combined into a single section. Furthermore, each of thus configured sections can be referred to as a means and achieved not only as a software section but also as a hardware section. For example, the image synthesizing ECU 9 may include an image display control section and a guide line overlapping section, the image display control section may perform a process including S170, and the guide line overlapping section may perform a process including S180.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. A vehicle surrounding monitoring device for assisting a forward parking of a vehicle, comprising:
an image display control section configured to make a view image based on a shot image that is shot by a camera for shooting a surrounding of the vehicle, the image display control section configured to display the view image on a display device disposed in the vehicle; and
a guide line overlapping section configured to overlap a guide line for assisting the forward parking of the vehicle on the view image, the guide line including a front end guide line, the front end guide line being a straight line extending from a first position to a second position, the first position being a position obtained by rotationally transferring a position of a rotational outer front end of the vehicle by 90 degrees around a rotational center of the vehicle, the second position located at a distance of a width of the vehicle from the first position toward a rear in a front-rear direction of the vehicle.

2. The vehicle surrounding monitoring device according to claim 1, wherein:
the guide line further includes a side guide line;
the side guide line extends from the second position to a third position; and
the third position is away from the second position toward the vehicle in a left-right direction of the vehicle.

3. The vehicle surrounding monitoring device according to claim 1, wherein
the rotational center is a rotational center at a case where a steering angle of the vehicle is a maximum to a left or right.

4. The vehicle surrounding monitoring device according to claim 1, wherein:
the guide line further includes a rotational outer track guide line and a rotational inner track guide line;
the rotational outer track guide line is an arc extending from the position of the rotational outer front end to the first position along a maximum rotation track centering on the rotational center; and
the rotational inner track guide line is an arc extending from a position of an inner rear wheel along a minimum rotation track centering on the rotational center.

5. The vehicle surrounding monitoring device according to claim 1, wherein
the guide line overlapping section is configured to start to operate when a speed of the vehicle becomes less than or equal to a predetermined speed.

6. The vehicle surrounding monitoring device according to claim 1, wherein
the guide line overlapping section is configured to start to operate when the vehicle enters a parking lot.

7. The vehicle surrounding monitoring device according to claim 1, wherein
the guide line overlapping section is configured to stop overlapping the guide line when a steering angle of the vehicle returns to a straight position, when an ignition switch of the vehicle is turned off, when the vehicle stops, or when a posture of the vehicle rotates 90 degrees from a posture at a time when the guide line overlapping section starts overlapping the guide line.

8. The vehicle surrounding monitoring device according to claim 1, wherein:
the image display control section is configured to extract a portion including an image of diagonally forward from a side shot image that is shot by a wide-angle side camera for shooting a side of the vehicle;
the image display control section is configured to treat a extracted image with a distortion compensation to make a side view image and display the side view image on the display device as one of the view image; and
the guide line overlapping section is configured to overlap the guide line on the side view image.

9. The vehicle surrounding monitoring device according to claim 8, wherein
the image display control section is configured to display a top view image viewed from above the vehicle on the display device simultaneously with the side view image.

10. The vehicle surrounding monitoring device according to claim 9, wherein:
the guide line further includes a rotational outer track guide line and a rotational inner track guide line;
the rotational outer track guide line is an arc extending from the position of the rotational outer front end to the first position along a maximum rotation track centering on the rotational center;
the rotational inner track guide line is an arc extending from a position of an inner rear wheel along a minimum rotation track centering on the rotational center;
the top view image includes an image of the vehicle facing upward of a screen of the display device;
the rotational outer track guide line overlapped on the side view image has an end adjacent to the top view image; and
in the screen, a front end of the image of the vehicle is arranged at a position lower than the end of the rotational outer track guide line.

11. The vehicle surrounding monitoring device according to claim 10, wherein
the image display control section is configured to make a left view image based on a side shot image shot by a side camera for shooting a left of the vehicle, a right view image based on a side shot image shot by a side camera for shooting a right of the vehicle, and a top view image viewed from above the vehicle, and
the image display control section is configured to simultaneously display the left view image, the top view image, and the right view image on the display device as the view image.

12. The vehicle surrounding monitoring device according to claim 11, wherein
the left view image is displayed in a first display section, the top view image is displayed in a second display section, and the left view image is displayed in a third display section, and
a ratio of areas of the first display section, the second display section, and the third display section are variable.

13. The vehicle surrounding monitoring device according to claim 12, wherein
the ratio of the areas changes based on a driving operation by a driver of the vehicle.

14. The vehicle surrounding monitoring device according to claim 11, wherein
the guide line overlapping section is configured to overlap the guide line on one of the left view image and the right view image, and
the image display control section is configured to set the area of the display section of the one of the left view image and the right view image to be larger than the area of the display section of the other one of the left view image and the right view image.

15. A vehicle surrounding monitoring device comprising
an image display control section configured to make a left view image based on a side shot image shot by a side camera for shooting a left of a vehicle, a right view image based on a side shot image shot by a side camera for shooting a right of the vehicle, and a top view image viewed from above the vehicle, the image display control section configured to simultaneously display the left view image, the top view image, and the right view image on a display device disposed in the vehicle, wherein
the left view image is displayed in a first display section, the top view image is displayed in a second display section, and the left view image is displayed in a third display section, and
a ratio of areas of the first display section, the second display section, and the third display section is variable.

16. A method of controlling a vehicle surrounding monitoring device that assists a forward parking of a vehicle, the method comprising:
making a view image based on an image short by a camera for shooting a surrounding of the vehicle;
displaying the view image on a display device disposed in the vehicle; and
overlapping a guide line for assisting the forward parking of the vehicle on the view image, the guide line including a front end guide line, the front end guide line being a straight line extending from a first position to a second position, the first position being a position obtained by rotationally transferring a position of a rotational outer front end of the vehicle by 90 degrees around a rotational center of the vehicle, the second position located at a distance of a width of the vehicle from the first position toward a rear in a front-rear direction of the vehicle.

17. A program product stored in a computer readable storage medium comprising instructions for execution by a computer, the instructions including the method according to claim 16.

18. A method of controlling a vehicle surrounding monitoring device, comprising:
making a left view image based on a side shot image shot by a side camera for shooting a left of a vehicle, a right view image based on a side shot image shot by a side camera for shooting a right of the vehicle, and a top view image viewed from above the vehicle; and
simultaneously displaying the left view image, the right view image, and the top view image on a display device disposed in the vehicle, wherein
the left view image is displayed in a first display section, the top view image is displayed in a second display section, and the left view image is displayed in a third display section, and
a ratio of areas of the first display section, the second display section, and the third display section is variable.

19. A program product stored in a computer readable storage medium comprising instructions for execution by a computer, the instructions including the method according to claim 18.
